(19) United States
(12) Patent Application Publication
(10) Pub. No.: US 2025/0013714 A1
(43) Pub. Date: Jan. 9, 2025

(54) METHOD AND APPARATUS WITH NEURAL NETWORK OPERATION AND KEYWORD IDENTIFICATION

(71) Applicant: Samsung Electronics Co., Ltd., Suwon-si (KR)

(72) Inventors: Jaehyuk LEE, Suwon-si (KR); Dong-Jin CHANG, Suwon-si (KR); Sungmeen MYUNG, Suwon-si (KR); Daekun YOON, Suwon-si (KR); Seok Ju YUN, Suwon-si (KR)

(73) Assignee: Samsung Electronics Co., Ltd., Suwon-si (KR)

(21) Appl. No.: 18/764,855

(22) Filed: Jul. 5, 2024

(30) Foreign Application Priority Data
Jul. 5, 2023 (KR) 10-2023-0087231

(51) Int. Cl. G06F 17/15

(52) U.S. Cl. CPC G06F 17/15

(57) ABSTRACT

A processor-implemented method includes receiving an input vector comprising a plurality of channels, performing a first convolution operation by allocating first chunks, obtained by dividing the input vector, to a plurality of first in-memory computing (IMC) macros, and performing a second convolution operation by allocating second chunks obtained by dividing a result of the first convolution operation to a plurality of second IMC macros.

### CROSS-REFERENCE TO RELATED APPLICATIONS

This application claims the benefit under 35 USC § 119 (a) of Korean Patent Application No. 10-2023-0087231, filed on Jul. 5, 2023 in the Korean Intellectual Property Office, the entire disclosure of which is incorporated herein by reference for all purposes.

### BACKGROUND

### 1. Field

The following description relates to a method and apparatus with a neural network operation and a keyword identification.

### 2. Description of Related Art

A convolutional neural network (CNN), a deep neural network (DNN), may be used in various application fields such as, for example, image and signal processing, object recognition, computer vision, and the like that mimic the human optic nerve. The CNN may be configured to perform a multiplication and accumulation (MAC) operation that repeats multiplication and addition using a considerably large number of matrices.

For example, when an application of a CNN is executed using general-purpose processors, an operation that uses a considerable operation quantity but is not complex, such as a MAC operation that calculates an inner product of two vectors and accumulates and sums the values, may be performed through in-memory computing (IMC).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes: receiving an input vector comprising a plurality of channels; performing a first convolution operation by allocating first chunks, obtained by dividing the input vector, to a plurality of first in-memory computing (IMC) macros; and performing a second convolution operation by allocating second chunks obtained by dividing a result of the first convolution operation to a plurality of second IMC macros.

The performing of the first convolution operation may include dividing the input vector into the first chunks in a channel direction of the input vector to match a structure of the plurality of first IMC macros.

The dividing of the input vector into the first chunks may include dividing the input vector into the first chunks such that a size of each of the channels of the input vector comprised in a first chunk is less than or equal to a number of rows of the plurality of first IMC macros.

A size of a first chunk of the first chunks may be less than or equal to a number of rows of a first IMC macro of the first IMC macros, and a number of the first chunks may equal a number of the first IMC macros.

The performing of the first convolution operation may include performing the first convolution operation on the first chunks in a time direction.

The performing of the first convolution operation may include performing the first convolution operation by applying a different activation function to each of the plurality of first IMC macros to which the first chunks are allocated.

The performing of the first convolution operation further may include: performing a batch normalization (BN) operation based on the result of the first convolution operation; and performing a first activation operation based on a result of the BN operation.

The performing of the first activation operation may include performing a hard (H)-swish 8 activation operation based on a rectified linear unit (ReLU) 8 function based on the result of the BN operation.

The performing of the second convolution operation may include: concatenating the result of the first convolution operation together; dividing the concatenated result of the first convolution operation into the second chunks; and performing the second convolution operation by allocating the second chunks to the plurality of second IMC macros.

The dividing of the concatenated result of the first convolution operation into the second chunks may include dividing the concatenated result of the first convolution operation into the second chunks such that a size of each channel of the concatenated result of the first convolution operation is less than or equal to a number of rows of the plurality of second IMC macros.

The method may include: matching a size of a result of the second convolution operation to a size of the input vector; and performing an add operation between the result of the second convolution operation matched to the size of the input vector and an input value of the first convolution operation.

The method may include: performing a pooling operation based on a result of the add operation; and performing a fully connected operation based on a result of the pooling operation.

Either one or both of the plurality of first IMC macros and the plurality of second IMC macros may be configured to perform frame-wise incremental computation.

The input vector may correspond to at least a portion of a sequentially input audio stream and the dividing of the input vector may include dividing the input vector based on the audio stream, and the method may include identifying a keyword comprised in the audio stream based on a result of the second convolution operation.

The first convolution operation and the second convolution operation may include a one-dimensional (1-D) convolution operation.

In one or more general aspects, a non-transitory computer-readable storage medium may store instructions that, when executed by one or more processors, configure the one or more processors to perform any one, any combination, or all of operations and methods herein.

In one or more general aspects, a processor-implemented method includes: receiving an audio stream; performing a first convolution operation on first chunks obtained by dividing an input vector comprising a plurality of channels based on the audio stream; performing a second convolution operation on second chunks obtained by dividing a result of the first convolution operation; and identifying a keyword comprised in the audio stream based on a result of the second convolution operation.

The performing of the first convolution operation may include: dividing the input vector into the first chunks such that a size of each of the channels of the input vector comprised in a first chunk is less than or equal to a number of rows of a plurality of first in-memory computing (IMC) macros; and performing the first convolution operation by allocating the first chunks to the plurality of first IMC macros.

The performing of the second convolution operation may include: concatenating the result of the first convolution operation together; dividing the concatenated result of the first convolution operation into the second chunks such that a size of each channel of the concatenated result of the first convolution operation is less than or equal to a number of rows of the plurality of second IMC macros; and performing the second convolution operation by allocating the second chunks to the plurality of second IMC macros.

In one or more general aspects, an apparatus includes: a receiver configured to receive an input vector comprising a plurality of channels; one or more processors configured to divide the input vector into first chunks, perform a first convolution operation by allocating the first chunks to a plurality of first in-memory computing (IMC) macros, concatenate a result of the first convolution operation together, divide the concatenated result of the first convolution operation into second chunks, and perform a second convolution operation by allocating the second chunks to a plurality of second IMC macros; and a memory device comprising either one or both of the plurality of first IMC macros and the plurality of second IMC macros.

For the dividing of the input vector, the one or more processors may be configured to divide the input vector into the first chunks such that a size of the input vector comprised in a first chunk in a channel direction is less than or equal to a number of rows of the plurality of first IMC macros.

Other features and aspects will be apparent from the following detailed description, the drawings, and the claims.

### BRIEF DESCRIPTION OF THE DRAWINGS

FIG. 1 illustrates an example of an in-memory computing (IMC) system for performing a multiplication and accumulation (MAC) operation of a neural network.

FIG. 2 illustrates an example of a neural network operation apparatus.

FIG. 3 illustrates an example of a keyword identification apparatus.

FIGS. 4A and 4B illustrate examples of a structure of a neural network used by a neural network operation apparatus.

FIG. 5 illustrates an example of a configuration of a neural network.

FIG. 6 illustrates an example of a configuration of a convolutional block.

FIGS. 7A and 7B illustrate examples of a method of allocating convolutional blocks to IMC macros.

FIG. 8 illustrates an example of a neural network operation method.

FIG. 9 illustrates an example of a neural network operation method.

FIG. 10 illustrates an example of a neural network operation method.

FIG. 11 illustrates an example of a keyword identification method based on a neural network operation.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “connected to,” “coupled to,” or “joined to” another component or element, it may be directly (e.g., in contact with the other component or element) “connected to,” “coupled to,” or “joined to” the other component or element, or there may reasonably be one or more other components or elements intervening therebetween. When a component or element is described as “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as will be commonly understood by one of ordinary skill in the art to which the present disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

Hereinafter, examples will be described in detail with reference to the accompanying drawings. When describing the examples with reference to the accompanying drawings, like reference numerals refer to like elements and a repeated description related thereto will be omitted.

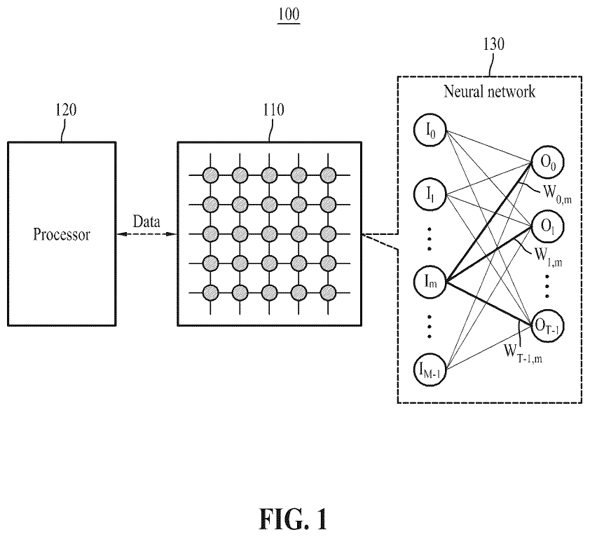

FIG. 1 illustrates an example of an in-memory computing (IMC) system for performing a multiplication and accumulation (MAC) operation of a neural network.

IMC may include a computer architecture for directly performing operations in a memory storing data such that data movement between a processor 120 (e.g., one or more processors) and a memory device 110 (e.g., including one or more memories) may be reduced and power efficiency may increase. The processor 120 of an IMC system 100 may input data to be operated to the memory device 110, and the memory device 110 may autonomously perform an operation on the input data. The processor 120 may minimize the movement of data during the operation process by reading a result of the operation from the memory device 110.

For example, the IMC system 100 may perform a MAC operation used in an artificial intelligence (AI) algorithm among various operations.

A neural network 130 may refer to a model having a problem-solving ability implemented through nodes forming a network through synaptic connections where the strength of the synaptic connections is changed through training. The neural network 130 may include one or more layers, each including one or more nodes. A node of the neural network 130 may include a combination of weights or biases. The neural network 130 may infer a desired result from a predetermined input by changing the weights of the nodes through training. As illustrated in FIG. 1, an operation between layers in the neural network 130 may include a MAC operation of adding results obtained by multiplying weights by each input value of input nodes.

The neural network 130 may include a deep neural network. The neural network 130 may include at least one of a convolutional neural network (CNN), a recurrent neural network (RNN), a perceptron, a multilayer perceptron, a feed forward (FF), a radial basis function network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and/or an attention network (AN).

The MAC operation may be expressed, for example, as in Equation 1 below, for example.

$${O}_{0} = {\sum }_{m = 0}^{M - 1} {I}_{m} {W}_{0 , m} , {o}_{1} {\sum }_{m = 0}^{M - 1} {I}_{m} {W}_{1 , m} , … , {o}_{τ - 1} = {\sum }_{m = 0}^{M - 1} {I}_{m} {W}_{T - 1 , m} \qquad Equation 1$$

In Equation 1, Oₜ may denote an output to a t-th node, Iₘ may denote an m-th input, and W_{t,m} may denote a weight applied to the m-th input, which is input to the t-th node. Here, Oₜ may be an output of a node or a node value and may be calculated as a weighted sum of the input Iₘ and the weight W_{t,m}. Here, m may be an integer of 0 or more and M−1 or less, t may be an integer of 0 or more and T−1 or less, and M and T may be integers. M may be the number of nodes of a previous layer connected to one node of a current layer to be operated, and T may be the number of nodes of the current layer.

The memory device 110 of the IMC system 100 may perform the described-above MAC operation. The memory device 110 may include IMC macros that perform the above-described MAC operation. The memory device 110 may also be referred to as a “memory array” or an “IMC device”.

The memory device 110 may also be used to store the memory and drive an algorithm including a multiplication operation in addition to the MAC operation. The memory device 110 of one or more embodiments may directly perform an operation in a memory without moving data, thereby reducing data movement and also improving area efficiency.

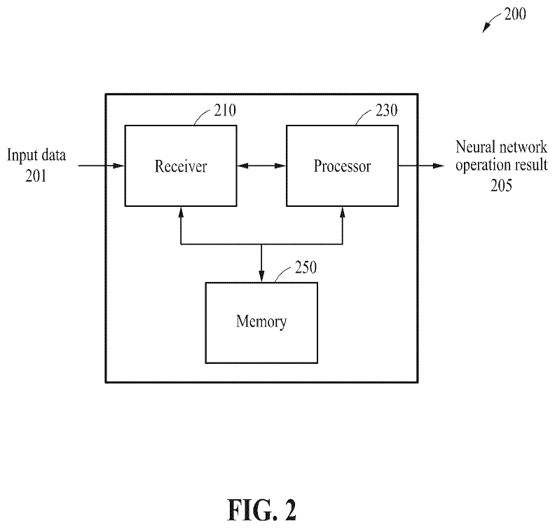

FIG. 2 illustrates an example of a neural network operation apparatus. Referring to FIG. 2, a neural network operation apparatus 200 may perform a neural network operation based on input data 201. The input data 201 may include an input vector including a plurality of channels and/or an input vector sequence. The input vector may correspond to, for example, at least a part of a sequentially input speech signal or audio stream. However, examples are not limited thereto.

The input data 201 may be input in real time. In an example, only a portion of the input data 201, rather than the input data 201 entirely, may be changed each time.

The neural network operation apparatus 200 may process the input data 201 and output a neural network operation result 205.

The neural network operation apparatus 200 may include a receiver 210 and a processor 230 (e.g., one or more processors). The neural network operation apparatus 200 may further include a memory 250 (e.g., the memory device 110 of FIG. 1).

The receiver 210 may include a receiving interface. The receiver 210 may receive input data. The receiver 210 may receive, for example, an input vector including a plurality of channels. The input vector may correspond to a predetermined point in time in the input vector sequence. The receiver 210 may output the received input data to the processor 230.

The processor 230 may process data stored in the memory 250. The processor 230 may execute computer-readable code (e.g., software) stored in the memory 250 and instructions triggered by the processor 230.

The processor 230 may be a hardware-implemented data processing device having a circuit that is physically structured to execute desired operations. The desired operations may include, for example, code or instructions included in a program.

The hardware-implemented data processing device may include, for example, a microprocessor, a central processing unit (CPU), a processor core, a multi-core processor, a multiprocessor, a neural processing unit (NPU), an application-specific integrated circuit (ASIC), and a field-programmable gate array (FPGA).

The processor 230 may train a neural network (e.g., the neural network 130 of FIG. 1). The processor 230 may train the neural network based on the input data 201 and perform the neural network operation based on the trained neural network.

The processor 230 may perform a convolution operation by dividing the input data 201 (e.g., an input vector) into chunks and allocating the chunks to IMC macros of the memory 250. Herein, chunk(s) may correspond to a part of the input data 201 divided into smaller sizes to match the number of rows of an IMC macro. In addition, herein, “dividing” input data or an operation result into chunks (e.g., first chunks and second chunks) may be understood as splitting or separating the input data or operation result into chunks. When divided chunks are concatenated together, the concatenated chunks may form a single vector of the same size as the input vector.

The processor 230 may perform a first convolution operation by dividing the input vector into first chunks and allocating the first chunks to a plurality of first IMC macros included in the memory 250. The processor 230 may divide the input vector into the first chunks in a channel direction of the input vector to match the structure of the plurality of first IMC macros. The processor 230 may divide the input vector into the first chunks such that the size of each of the channels of the input vector is less than or equal to the number of rows of the plurality of first IMC macros. For example, a size of a first chunk may be less than or equal to a number of rows of a first IMC macro, and a total number of the first chunks may equal a total number of the first IMC macros. The processor 230 may perform the first convolution operation on the first chunks in a time direction. The processor 230 may perform the first convolution operation by applying a different activation function to each of the plurality of first IMC macros to which the first chunks are allocated.

The processor 230 may perform a batch normalization (BN) operation based on a result of the first convolution operation. The processor 230 may perform a first activation operation based on a result of the BN operation. For example, the processor 230 may perform a hard (H)-swish 8 activation operation based on a rectified linear unit (ReLU) 8 function based on the result of the BN operation.

The processor 230 may concatenate the result of the first convolution operation together and divide the concatenated result of the first convolution operation into second chunks. The processor 230 may divide the concatenated result of the first convolution operation into the second chunks such that the size of each channel of the concatenated result of the first convolution operation is less than or equal to the number of rows of a plurality of second IMC macros. The processor 230 may perform a second convolution operation by allocating the second chunks to the plurality of second IMC macros included in the memory 250. The processor 230 may output a result of the second convolution operation as the neural network operation result 205.

The first convolution operation and the second convolution operation may include a one-dimensional (1-D) convolution operation. By performing the 1-D convolution operation, the neural network operation apparatus 200 of one or more embodiments may reduce the size of input activation relative to the same number of parameters and decrease an operation quantity.

The processor 230 may match the size of the result of the second convolution operation to the size of the input vector. The processor 230 may perform an add operation between the result of the second convolution operation matched to the size of the input vector and an input value of the first convolution operation.

The processor 230 may perform a pooling operation based on a result of the add operation. The pooling operation may refer to an operation that extracts only a portion of components from a region of the input data corresponding to a kernel size. The pooling operation may include, for example, a max pool operation, an average pool operation, and a sum pool operation.

The processor 230 may perform a fully connected operation based on a result of the pooling operation. The fully connected operation may be an operation performed by a fully connected layer in which all nodes of a previous layer are connected to all nodes of a next layer. The processor 230 may output a result of performing the fully connected operation as the neural network operation result 205.

The memory 250 may include at least one of the plurality of first IMC macros and the plurality of second IMC macros. In addition, the memory 250 may store a neural network model or parameters of the neural network model. The memory 250 may store instructions (or programs) executable by the processor 230. For example, the instructions may include instructions for executing an operation of the processor 230 and/or instructions for executing an operation of each component of the processor 230.

The memory 250 may be implemented as a volatile or non-volatile memory device. The volatile memory device may be implemented as dynamic random access memory (DRAM), static RAM (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, and/or an insulator resistance change memory.

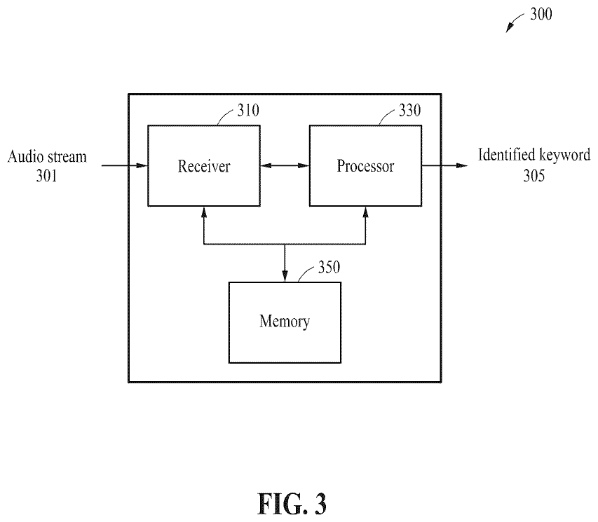

FIG. 3 illustrates an example of a keyword identification apparatus. Referring to FIG. 3, a keyword identification apparatus 300 may identify and/or detect a keyword from an audio stream 301. The keyword identification apparatus 300 may identify and/or detect a keyword by processing the audio stream 301 using a neural network (e.g., the neural network 130 of FIG. 1).

The keyword identification apparatus 300 may be embodied as a printed circuit board (PCB) such as a motherboard, an integrated circuit (IC), and/or a system on a chip (SoC). The keyword identification apparatus 300 may be embodied as an application processor, for example. In addition, the keyword identification apparatus 300 may be included in a personal computer (PC), a data server, and/or a portable device. The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld game console, an e-book, and/or a smart device. The smart device may be implemented as a smartwatch, a smart band, smart glass, and/or a smart ring.

The keyword identification apparatus 300 may perform keyword identification using the neural network operation apparatus 200 of FIG. 2. Alternatively or additionally, the keyword identification apparatus 300 may perform keyword identification using separate hardware.

The keyword identification apparatus 300 may include a receiver 310 and a processor 330 (e.g., one or more processors). The keyword identification apparatus 300 may further include a memory 350 (e.g., one or more memories).

The receiver 310 may receive the audio stream 301. The audio stream 301 may include not only human voice including a natural language but also various sounds such as mechanical sounds, electronic sounds, natural sounds, musical instrument sounds, and the like. The receiver 310 may include a receiving interface. The receiver 310 may output the received audio stream 310 to the processor 330.

The processor 330 may generate an input vector sequence by extracting a feature from the audio stream 301. The input vector sequence may include a plurality of channels. The processor 330 may divide some input vectors of the input vector sequence including the plurality of channels based on the audio stream 301 into first chunks and perform a first convolution operation on the first chunks.

The processor 330 may concatenate a result of the first convolution operation together, divide the result again into second chunks, and perform a second convolution operation on the second chunks. The processor 330 may identify and/or detect a keyword included in the audio stream 301 based on a result of the second convolution operation. The processor 330 may output an identified and/or detected keyword 305.

The processor 330 may perform the first convolution and the second convolution in the same way as the processor 230 illustrated in FIG. 2 performs them. Other operations of the processor 330 may be the same as the operations of the processor 230 of FIG. 2, and thus, the description of the processor 230 of FIG. 2 is applicable to the processor 330. Similarly, the memory 350 may operate in the same way as the memory 250 of FIG. 2, and thus, the description of the memory 250 of FIG. 2 is applicable to the memory 350.

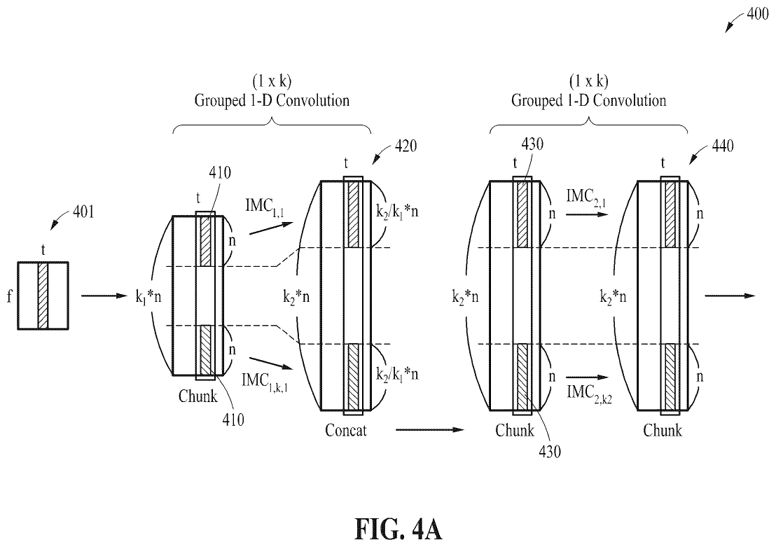

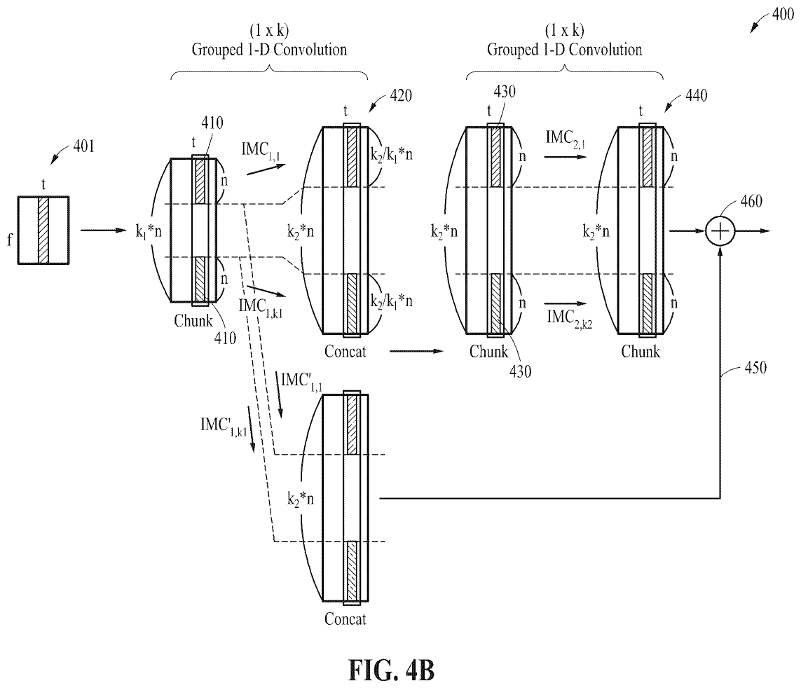

FIGS. 4A and 4B illustrate examples of a structure of a neural network used by a neural network operation apparatus (e.g., the structure of a neural network used by the neural network operation apparatus illustrated in FIG. 2). FIG. 4A illustrates the structure of a neural network 400 that performs a 1-D convolution operation by grouped IMC macros.

Input data may be input to the neural network 400 in real time. The input data may be, for example, an input vector 401 corresponding to a frequency characteristic of a speech input at a predetermined point in time. The input vector 401 may be, for example, a mel-frequency cepstral coefficient (MFCC) but is not limited thereto. An MFCC may correspond to a feature in which unnecessary information in relation to voice recognition is discarded and only important characteristics are left. In the input vector 401, the x-axis may represent time (t) and the y-axis may represent a frequency (f) component. FIG. 4A illustrates that 2-D input data in the form of f×t is input, but a 1-D input vector (e.g., the input vector 401) in a frequency direction may be applied to the neural network 400 in real time. The neural network 400 may be trained on the 2-D input data, and the neural network operation apparatus may process the 1-D input vector (e.g., the input vector 401), among the input data, corresponding to a frequency characteristic of a sound input (e.g., speech) at a predetermined point in time in real time. A portion of the input data, rather than the input data entirely, may be changed each time.

The neural network 400 of one or more embodiments may be configured to perform a 1-D convolution operation in a time direction using a small number of filters in order to minimize the operation quantity and storage space used by hardware each time.

The neural network operation apparatus may set a module as a basic unit. The module may be configured to match the size of the input vector 401 in a channel direction, wherein the input vector 401 is responsible for a feature in each layer of the neural network 400, to the number (e.g., n) of rows of first IMC macros (IMC_{1,1}, IMC_{1, K1}).

The neural network operation apparatus may divide the input vector 401 into first chunks 410 in the channel direction of the input vector 401 to match the structure of the first IMC macros (IMC_{1,1}, IMC_{1,K1}). The neural network operation apparatus may divide the input vector 401 into chunks (e.g., the first chunks 410) such that the size of each of the channels of the input vector 401 comprised in a first chunk 410 is less than or equal to the number of rows of the first IMC macros (IMC_{1,1}, IMC_{1,K1}). In other words, the neural network operation apparatus may divide the input vector 401 into k₁ first chunks 410 corresponding to a multiple of the number (n) of rows of the first IMC macros (IMC_{1,1}, IMC_{1,K1}). The size of an input channel of each of the first IMC macros (IMC_{1,1}, IMC_{1,K1}) may be n, and the number of first IMC macros (IMC_{1,1}, IMC_{1,K1}) may be K₁. The neural network operation apparatus may divide the input vector 401 into K₁ first chunks 410 and perform the first convolution operation on the input vector 401 through a group of K₁ IMC macros. The circuit-level interpretation of the phrase “dividing the input vector 401 into chunks (e.g., the first chunks 410)” may be understood as the process of mapping data of the input vector 410 to a memory address.

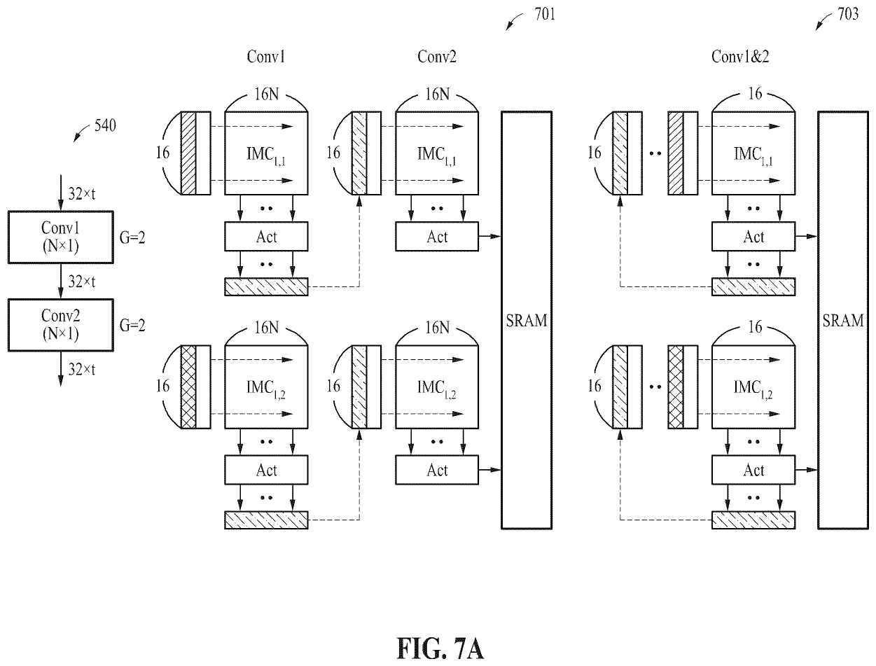

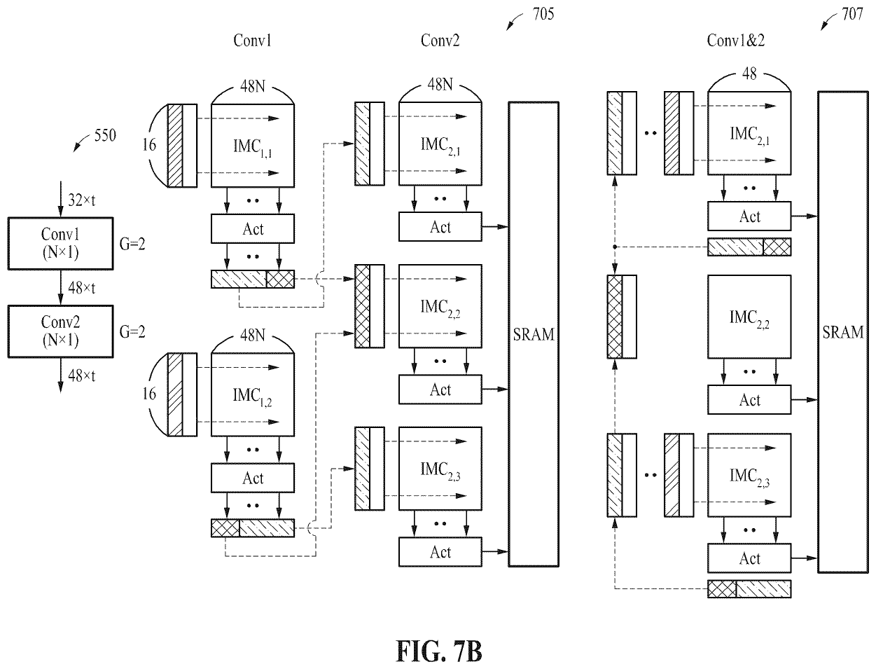

The neural network operation apparatus may divide the input vector 401 having a wide channel into k₁ first chunks 410 to match the number (n) of rows of the first IMC macros (IMC_{1,1}, IMC_{1,K1}) to perform an operation on a large-sized feature map through small-sized IMC macros. The neural network operation apparatus of one or more embodiments may divide the input vector 401 into K₁ first chunks 410 and perform an operation to minimize data movement by allowing the IMC macros to be pipelined, for example, like a diagram 701 of FIG. 7A or a diagram 705 of FIG. 7B. The neural network operation apparatus of one or more embodiments may perform an operation (e.g., a convolution operation) on K₁ first chunks 410 through the group of the plurality of first IMC macros (IMC_{1,1}, IMC_{1,K1}), thereby reducing not only the number of memory accesses but also the number of parameters and an operation quantity of the neural network 400.

The neural network operation apparatus may perform a convolution operation (e.g., the first convolution operation) on the first chunks 410 in a time direction. The neural network operation apparatus may perform the first convolution operation by applying a different activation function to each of the first IMC macros (IMC_{1,1}, IMC_{1,K1}) to which the first chunks 410 are allocated. The first convolution operation may be a 1-D convolution operation rather than a depth-wise convolution operation. The first convolution operation may be performed by a convolutional layer having a size of 1×k, for example.

The size of the first chunks 410 may be (k₂/k₁)*n through the first convolution operation, and accordingly, the horizontal size of the first IMC macros (IMC_{1,1}, IMC_{1,K1}) may be also (k₂/k₁)*n. Inputs (e.g., the first chunks 410) may be processed in parallel in (k₂/k₁)*n columns of the first IMC macros (IMC_{1,1}, IMC_{1,K1}). The first IMC macros (IMC_{1,1}, IMC_{1,K1}) may enable element-wise addition and/or multiplication operations to be performed on values of the first chunks 410.

The neural network operation apparatus may perform a BN operation (e.g., a first BN operation) based on a result of the first convolution operation. In an example, when the neural network 400 only performs inference without training, the execution of the BN operation may be omitted.

The number of input channels and the number of output channels of each convolutional block of the neural network 400 may be different. Also, in order to express or create more features, the number of output channels corresponding to the result of the first convolution operation may be equal to the number of filters of each convolution operation.

The neural network operation apparatus may perform a first activation operation based on a result of the first BN operation. The neural network operation apparatus may apply a different activation function to the first chunks 410 allocated to each of the first IMC macros (IMC_{1,1}, IMC_{1,K1}).

The neural network operation apparatus may perform the first activation operation by an H-swish 8 activation function based on a ReLU 8 based on a result of the first BN operation or perform the first activation operation by a ReLU. Hard swish is a type of activation function based on Swish but replaces the computationally expensive sigmoid with a piecewise linear analogue.

The H-swish 8 activation function may be expressed by Equation 2 below, for example.

$$H - swich 8 = x * max \{ 0 , min ( x + 4 , 8 ) \} / 8 \qquad Equation 2$$

While an H-swish activation function uses the number 6, the H-swish 8 activation function uses 8, which is the cube of 2. This enables the replacement of division with a technique such as bit-shifting in a digital circuit implemented in binary, making hardware implementation convenient.

The neural network operation apparatus may implement complex division required for an H-swish activation operation efficient for quantization through simple hardware such as a bit-shifter using a ReLU8(=max{0, min(x, 8)}) function.

The above-described first BN operation and the first activation operation may be optionally performed.

The neural network operation apparatus may concatenate the result of the first convolution operation together.

The neural network operation apparatus may divide the concatenated result 420 of the first convolution operation into k₂ second chunks 430. The neural network operation apparatus may divide the concatenated result 420 of the first convolution operation into the second chunks 430 such that the size of each channel of the concatenated result 420 of the first convolution operation is less than or equal to the number of rows of a plurality of second IMC macros (IMC_{2,1}, IMC_{2,K2}).

The neural network operation apparatus may perform a second convolution operation by allocating K₂ second chunks 430 to the plurality of second IMC macros (IMC_{2,1}, IMC_{2,K2}). The neural network operation apparatus may perform the second convolution operation on the second chunks 430 in a time direction. The second convolution operation may be a 1-D convolution operation.

The neural network operation apparatus may perform the second convolution operation by applying a different activation function to each of the plurality of second IMC macros (IMC_{2,1}, IMC_{2,K2}) to which K₂ second chunks 430 are allocated. The neural network operation apparatus may perform a second BN operation based on a result 440 of the second convolution operation. The neural network operation apparatus may perform a second activation operation based on a result of the second BN operation. The neural network operation apparatus may perform the H-swish 8 activation operation based on a ReLU 8 function based on the result of the second BN operation.

The neural network operation apparatus may perform an add operation 460 between the result 440 of the second convolution operation and an input value of the first convolution operation, as illustrated in FIG. 4B.

The neural network operation apparatus may match the size of the result 440 of the second convolution operation to the size of the input vector 401. The neural network operation apparatus may match the size of the result 440 of the second convolution operation to the size of the input vector 401 (or an input value of a first convolutional layer) and then establish a residual connection 450. The residual connection 450 is to provide an alternative path for data to reach the rear part of the structure of the neural network 400, preventing a gradient issue in which information learned at the lower layer of the neural network 400 is lost during a data processing process. The process of matching the size of the result 440 of the second convolution operation to the size of the input vector 401 (or the input value of the first convolutional layer) may be, for example, performed for a pipeline of IMC macros described later. However, examples are not limited thereto.

The neural network operation apparatus may adjust the size of a vector for final summation by inserting the input value of the first convolution operation, which is an input value before passing through the first convolutional layer, into the residual connection 450. The neural network operation apparatus may perform the add operation 460 between the result 440 of the second convolution operation matched to the size of the input vector 401 and the input value of the first convolution operation.

The neural network operation apparatus may perform a pooling operation based on a result of the add operation 460. The neural network operation apparatus may perform a fully connected operation based on a result of the pooling operation.

At least one of the first IMC macros (IMC_{1,1}, IMC_{1,K1}) or the second IMC macros (IMC_{2,1}, IMC_{2,K2}) illustrated in FIGS. 4A and 4B may perform frame-wise incremental computation. Frame-wise incremental computation may perform an operation on an input received in real time, instead of performing an operation (e.g., a convolution operation) on all inputs of each layer. When IMC macros (e.g., the first IMC macros (IMC_{1,1}, IMC_{1,K1}) and/or the second IMC macros (IMC_{2,1}, IMC_{2,K2})) perform frame-wise incremental computation, the neural network operation apparatus of one or more embodiments may reduce the size of a buffer, that is, the size of an activation buffer, used to store intermediate data, because only a part that is operated in real time needs to be stored in the buffer.

The neural network operation apparatus may reduce the size of a memory used to store an activation function by operating the input vector 401 in real time.

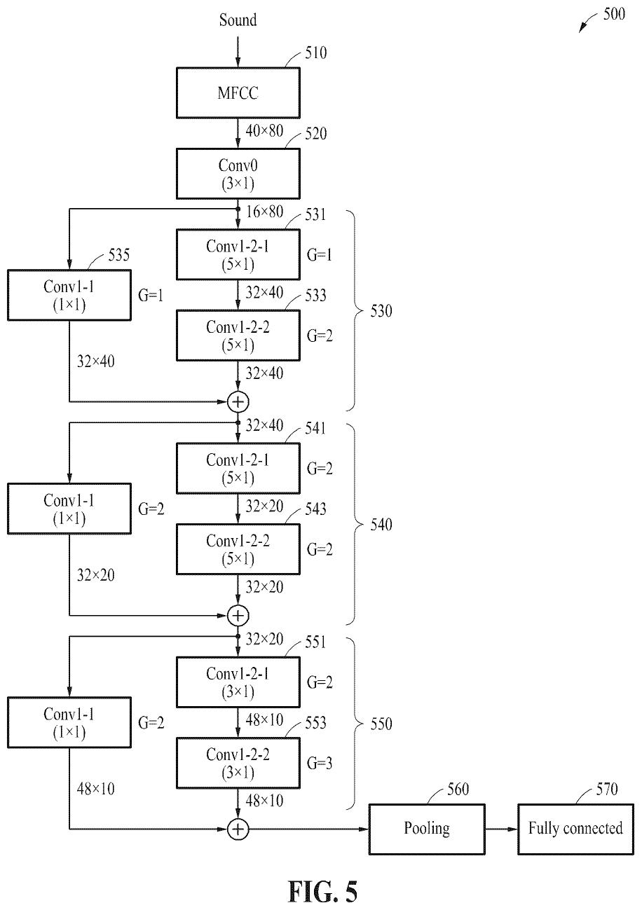

FIG. 5 illustrates an example of a configuration of a neural network. The above-described processor (the processors 230 and 330) may perform a neural network operation using a neural network having a structure illustrated in FIG. 5.

Referring to FIG. 5, a neural network 500 may include a feature extraction layer 510, a convolutional layer (Conv 0) 520, convolutional blocks 530 to 550, a pooling layer 560, and a fully connected layer 570. The neural network 500 may include the convolutional blocks 530 to 550 as a basic component unit.

The feature extraction layer 510 may perform feature extraction from input data (e.g., a speech signal or audio stream). The speech signal may have a magnitude that changes over time. The feature extraction layer 510 may extract a speech feature based on the speech signal or audio stream. The feature extraction layer 510 may extract the speech feature by processing the speech signal or audio stream based on frequency. The speech feature may correspond to a frequency feature that changes over time.

The processors 230 and 330 may extract a feature associated with the frequency of the input data using the feature extraction layer 510. The feature extraction layer 510 may extract the feature associated with the frequency of the input data using, for example, filter-bank energy, spectrogram, or linear predictive coding (LPC). For example, in a case in which the input data is a speech signal containing a natural language, the feature extraction layer 510 may extract a feature from the speech signal. The feature may have a form of a vector. For example, the processors 230 and 330 may divide the input speech signal into 10 milliseconds (ms)-interval frames using a 30 ms window and then extract an MFCC of 40 dimensions from each of the frames. The above-described input vector (e.g., the input vector 401 of FIG. 4A) may have a form of an MFCC vector extracted from the speech signal.

The convolutional layer (Conv 0) 520 may perform a convolution operation based on a previously extracted feature (e.g., MFCC). Through the convolutional layer 520, the processors 230 and 330 may perform the convolution operation on the feature (e.g., MFCC) in a longitudinal direction of a context.

The processors 230 and 330 may process an output of the convolutional layer 520 using the convolutional blocks 530 to 550. The convolutional block 530 may include, for example, a first convolutional layer (Conv1-2-1) (5×1) 531, a second convolutional layer (Conv1-2-2) (5×1) 533, and a 1×1 convolutional layer (Conv1-1) 535. However, examples are not limited thereto.

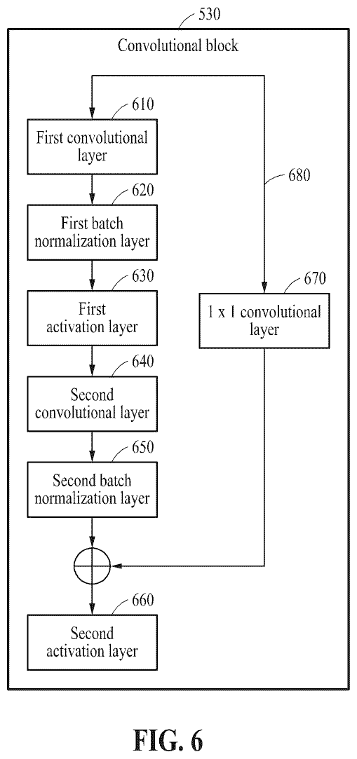

The first convolutional layer 531 may perform a first convolution operation on first chunks (e.g., the first chunks 410 of FIGS. 4A and 4B) obtained by dividing the input vector. The second convolutional layer 533 may concatenate a result of the first convolution operation together and perform a second convolution operation on second chunks (e.g., the second chunks 430 of FIGS. 4A and 4B) obtained by dividing the concatenated result of the first convolution operation. The 1×1 convolutional layer 535 may match a result of the second convolution operation to the size of the input vector. A configuration of the convolutional block 530 is described below in detail with reference to FIG. 6.

The first convolutional layer 531 of the convolutional block 530 may include one group of IMC macros, and the second convolutional layer 533 of the convolutional block 530 may include two groups of IMC macros.

A first convolutional layer 541 and a second convolutional layer 543 of the convolutional block 540 may each include two groups of IMC macros.

A first convolutional layer 551 of the convolutional block 550 may include two groups of IMC macros, and a second convolutional layer 553 may include three groups of IMC macros. Each layer of the convolutional blocks 530 to 550 may include various numbers of groups of IMC macros, as illustrated in FIG. 5. However, examples are not limited thereto.

The processors 230 and 330 may perform a pooling operation by inputting the convolutional block 550 to the pooling layer 560. The processors 230 and 330 may input a result of the pooling operation to the fully connected layer 570. The processors 230 and 330 may apply a softmax function (not shown) to an output of the fully connected layer 570.

FIG. 6 illustrates an example of a configuration of a convolutional block (e.g., the convolutional block illustrated in FIG. 5). Referring to FIG. 6, the convolutional block 530 may include a first convolutional layer 610 (e.g., the first convolutional layer 531 of FIG. 5), a first BN layer 620, a first activation layer 630, a second convolutional layer 640 (e.g., the second convolutional layer 533 of FIG. 5), a second BN layer 650, a second activation layer 660, and a 1×1 convolutional layer 670 (e.g., the 1×1 convolutional layer 535 of FIG. 5).

The first convolutional layer 610 may perform a first convolution operation on first chunks obtained by dividing an input vector. The first BN layer 620 may perform a BN operation on an operation result of the first convolutional layer 610 to improve the overall performance of a neural network (e.g., the neural network 400 of FIG. 4A). The processors 230 and 330 may perform a first BN operation through the first BN layer 620 disposed between the first convolutional layer 610 and the first activation layer 630. The first BN operation may be replaced with another normalization operation.

The first activation layer 630 may perform an H-swish 8 activation operation based on an operation result of the first BN layer 620.

The second convolutional layer 640 may concatenate an output of the first activation layer 630 and perform a second convolution operation on second chunks obtained by dividing the concatenated output of the first activation layer 630 again.

The second BN layer 650 may normalize a result of the second convolution operation in the second convolutional layer 640 through a BN operation.

The 1×1 convolutional layer 670 may match the result of the second convolution operation to the size of the input vector (or an input of the first convolutional layer 610).

Through the second activation layer 660, the processors 230 and 330 may perform a second activation operation on a result obtained by performing an add operation between the input of the first convolutional layer 610 that is from the 1×1 convolutional layer 670 and an output of the second BN layer 650, for a residual structure. The processors 230 and 330 may prevent a gradient of a loss for a weight of the neural network from being extremely small by adding a residual connection 680 (e.g., the residual connection 450 of FIG. 4B).

FIGS. 7A and 7B illustrate examples of a method of processing an operation of convolutional blocks (e.g., the convolutional blocks illustrated in FIG. 5) using IMC macros.

FIG. 7A illustrates diagrams 701 and 703 showing how the convolutional block 540 processes an operation when the size of groups of IMC macros corresponding to a first convolutional layer and the size of groups of IMC macros corresponding to a second convolutional layer are both G=2. The diagram 701 may show a processing method for throughput, and the diagram 703 may show a processing method for an area.

As described above, a neural network operation apparatus may perform an operation on a large-sized feature map through small-sized IMC macros by dividing an input vector having a wide channel into a plurality of chunks, aligning the number of chunks with the number of rows of IMC macros, and performing an operation.

When the number of groups of IMC macros for the first convolutional layer and the number of groups of IMC macros for the second convolutional layer are both G=2, the neural network operation apparatus may perform a first convolution operation and a second convolution operation by pipelining two IMC macros (IMC_{1,1}, IMC_{1,2}), improving throughput, as illustrated in the diagram 701.

Alternatively or additionally, the neural network operation apparatus may decrease an implementation area by successively utilizing the two IMC macros (IMC_{1,1}, IMC_{1,2}), as illustrated in the diagram 703.

FIG. 7B illustrates diagram s 705 and 707 showing how the convolutional block 550 processes an operation when the size of groups of IMC macros corresponding to a first convolutional layer is G=2 and the size of groups of IMC macros corresponding to a second convolutional layer is G=3.

The diagram 705 may show a processing method for throughput, and the diagram 707 may show a processing method for an area.

When the number of groups of first IMC macros is G=2 and the number of groups of second IMC macros is G=3, the neural network operation apparatus may perform a second convolution operation by distributing results of a first convolution operation in two first IMC macros (IMC_{1,1}, IMC_{1,2}) to three second IMC macros (IMC_{2,1}, IMC_{2,2}, MC_{2,3}), improving throughput, as illustrated in the diagram 705. The neural network operation apparatus may transmit some of the operation results (e.g., the results of the first convolution operation) of the first IMC macros (IMC_{1,1}) to the second IMC macros (IMC_{2,2}). The neural network operation apparatus may also transmit some of the operation results of the first IMC macros (IMC_{1,2}) to the second IMC macros (IMC_{2,2}). The neural network operation apparatus may concatenate some of the operation results of the first IMC macros (IMC_{1,1}) and some of the operation results of the first IMC macros (IMC_{1,2}) together, divide the concatenated results into second chunks, and allocate the second chunks to the second IMC macros (IMC_{2,2}).

Alternatively or additionally, when the number (G=2) of groups of the first IMC macros and the number (G=3) of groups of the second IMC macros are different, the neural network operation apparatus may perform a convolution operation using the second IMC macros having a larger number of groups. The neural network operation apparatus may decrease an implementation area by successively utilizing the three second IMC macros (IMC_{2,1}, IMC_{2,2}. IMC_{2,3}), as illustrated in the diagram 707.

The neural network operation apparatus may decrease access to SRAM by transmitting an output of the first IMC macros to the second IMC macros, as illustrated in FIGS. 7A and 7B.

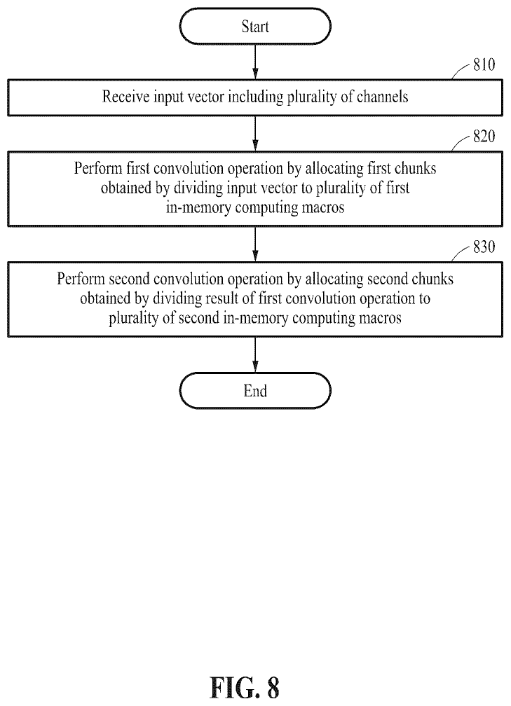

FIG. 8 illustrates an example of a neural network operation method. Referring to FIG. 8, a neural network operation apparatus may perform operations 810 to 830.

In operation 810, the neural network operation apparatus may receive an input vector including a plurality of channels.

In operation 820, the neural network operation apparatus may perform a first convolution operation by allocating first chunks obtained by dividing the input vector received in operation 810 to a plurality of first IMC macros. The neural network operation apparatus may divide the input vector into the first chunks in a channel direction of the input vector to match the structure of the plurality of first IMC macros. The neural network operation apparatus may divide the input vector into the first chunks such that the size of each of the channels of the input vector is less than or equal to the number of rows of the plurality of first IMC macros. The neural network operation apparatus may perform the first convolution operation on the first chunks in a time direction. In other words, the neural network operation apparatus may perform a temporal convolution on the first chunks with a filter having a predetermined length on a time axis.

The neural network operation apparatus may perform the first convolution operation by applying a different activation function to each of the plurality of first IMC macros to which the first chunks are allocated.

In operation 830, the neural network operation apparatus may perform a second convolution operation by dividing a result of the first convolution operation performed in operation 820 into second chunks and allocating the second chunks to a plurality of second IMC macros. The neural network operation apparatus may concatenate the result of the first convolution operation that is previously divided into the first chunks and processed and divide the concatenated result of the first convolution operation into second chunks again. The neural network operation apparatus may perform the second convolution operation by allocating the second chunks to the plurality of second IMC macros. For example, the neural network operation apparatus may divide the concatenated result of the first convolution operation into second chunks such that the size of each channel of the concatenated result of the first convolution operation is less than or equal to the number of rows of the plurality of second IMC macros.

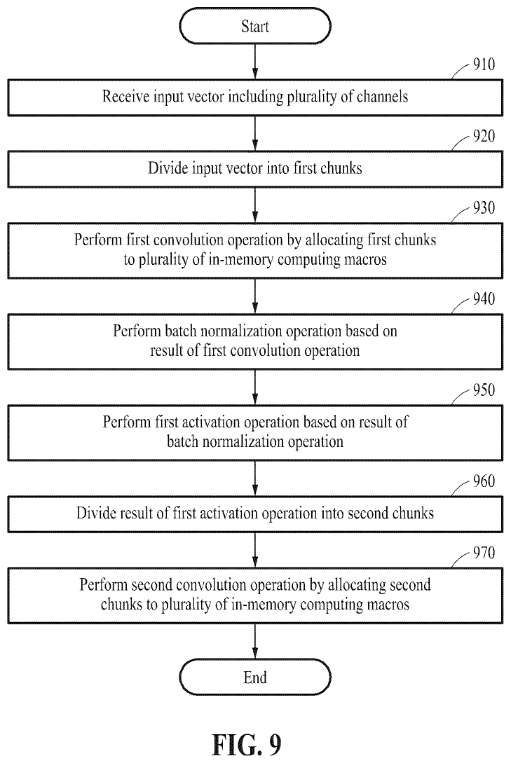

FIG. 9 illustrates an example of a neural network operation method. Referring to FIG. 9, a neural network operation apparatus may perform operations 910 to 970.

In operation 910, the neural network operation apparatus may receive an input vector including a plurality of channels.

In operation 920, the neural network operation apparatus may divide the input vector received in operation 920 into first chunks.

In operation 930, the neural network operation apparatus may perform a first convolution operation by allocating the first chunks obtained by dividing the input vector in operation 920 to a plurality of IMC macros (e.g., a plurality of first IMC macros).

In operation 940, the neural network operation apparatus may perform a BN operation based on a result of the first convolution operation performed in operation 930.

In operation 950, the neural network operation apparatus may perform a first activation operation based on a result of the BN operation performed in operation 940.

In operation 960, the neural network operation apparatus may divide a result of the first activation operation performed in operation 950 into second chunks.

In operation 970, the neural network operation apparatus may perform a second convolution operation by allocating the second chunks obtained by dividing the result of the first activation operation in operation 960 to a plurality of IMC macros (e.g., a plurality of second IMC macros).

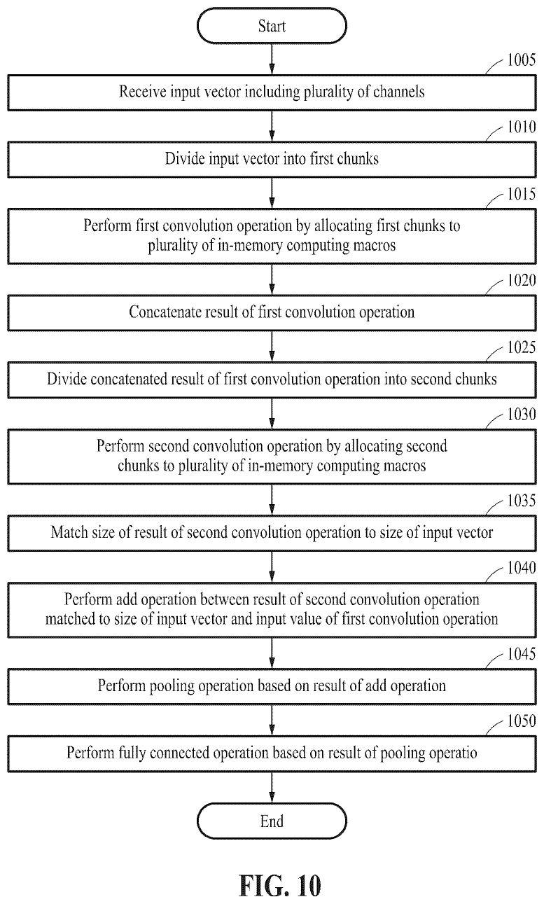

FIG. 10 illustrates an example of a neural network operation method. Referring to FIG. 10, a neural network operation apparatus may perform operations 1005 to 1050.

In operation 1005, the neural network operation apparatus may receive an input vector including a plurality of channels.

In operation 1010, the neural network operation apparatus may divide the input vector received in operation 1005 into first chunks.

In operation 1015, the neural network operation apparatus may perform a first convolution operation by allocating the first chunks obtained by dividing the input vector in operation 1010 to a plurality of IMC macros (e.g., a plurality of first IMC macros).

In operation 1020, the neural network operation apparatus may concatenate a result of the first convolution operation performed in operation 1015. The neural network operation apparatus may concatenate the result of the first convolution operation into a single vector form.

In operation 1025, the neural network operation apparatus may divide the result of the first convolution operation concatenated in operation 1020 into second chunks.

In operation 1030, the neural network operation apparatus may perform a second convolution operation by allocating the second chunks obtained by dividing the concatenated result of the first convolution operation in operation 1025 to a plurality of IMC macros (e.g., a plurality of second IMC macros).

In operation 1035, the neural network operation apparatus may match the size of a result of the second convolution operation performed in operation 1030 to the size of the input vector.

In operation 1040, the neural network operation apparatus may perform an add operation between the result of the second convolution operation matched to the size of the input vector and an input value of the first convolution operation.

In operation 1045, the neural network operation apparatus may perform a pooling operation based on a result of the add operation performed in operation 1040.

In operation 1050, the neural network operation apparatus may perform a fully connected operation based on a result of the pooling operation performed in operation 1045.

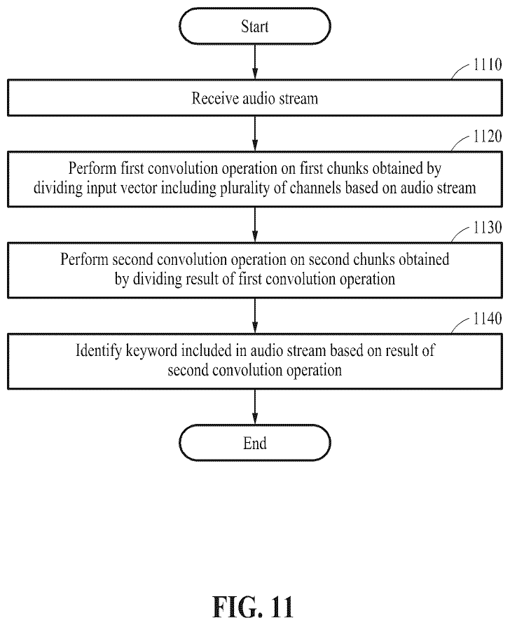

FIG. 11 illustrates an example of a keyword identification method based on a neural network operation. Referring to FIG. 11, a keyword identification apparatus may identify and extract a keyword from an audio stream through operations 1110 to 1140.

In operation 1110, the keyword identification apparatus may receive an audio stream.

In operation 1120, the keyword identification apparatus may perform a first convolution operation on first chunks obtained by dividing an input vector including a plurality of channels based on the audio stream received in operation 1110. For example, the keyword identification apparatus may divide the input vector into the first chunks such that the size of each of the channels of the input vector is less than or equal to the number of rows of a plurality of first IMC macros. The keyword identification apparatus may perform the first convolution operation by allocating the first chunks to the plurality of first IMC macros.

In operation 1130, the keyword identification apparatus may perform a second convolution operation on second chunks obtained by dividing a result of the first convolution operation performed in operation 1120. The keyword identification apparatus may concatenate the result of the first convolution operation performed in operation 1120 into a single vector. The keyword identification apparatus may divide the concatenated result of the first convolution operation into second chunks such that the size of each channel of the concatenated result of the first convolution operation is less than or equal to the number of rows of a plurality of second IMC macros. The keyword identification apparatus may perform the second convolution operation by allocating the second chunks to the plurality of second IMC macros.

In operation 1140, the keyword identification apparatus may identify a keyword included in the audio stream based on a result of the second convolution operation performed in operation 1130. The keyword identification apparatus may extract the identified keyword.

The IMC systems, memory devices, processors, neural network operation apparatuses, receivers, memories, keyword identification apparatuses, IMC system 100, memory device 110, processor 120, neural network operation apparatus 200, receiver 210, processor 230, memory 250, keyword identification apparatus 300, receiver 310, processor 330, memory 350, and other apparatuses, devices, units, modules, and components disclosed and described herein with respect to FIGS. 1-11 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-Res, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
receiving an input vector comprising a plurality of channels;
performing a first convolution operation by allocating first chunks, obtained by dividing the input vector, to a plurality of first in-memory computing (IMC) macros; and
performing a second convolution operation by allocating second chunks obtained by dividing a result of the first convolution operation to a plurality of second IMC macros.

2. The method of claim 1, wherein the performing of the first convolution operation comprises dividing the input vector into the first chunks in a channel direction of the input vector to match a structure of the plurality of first IMC macros.

3. The method of claim 2, wherein the dividing of the input vector into the first chunks comprises dividing the input vector into the first chunks such that a size of each of the channels of the input vector comprised in a first chunk is less than or equal to a number of rows of the plurality of first IMC macros.

4. The method of claim 2, wherein
a size of a first chunk of the first chunks is less than or equal to a number of rows of a first IMC macro of the first IMC macros, and
a number of the first chunks equals a number of the first IMC macros.

5. The method of claim 1, wherein the performing of the first convolution operation comprises performing the first convolution operation on the first chunks in a time direction.

6. The method of claim 1, wherein the performing of the first convolution operation comprises performing the first convolution operation by applying a different activation function to each of the plurality of first IMC macros to which the first chunks are allocated.

7. The method of claim 1, wherein the performing of the first convolution operation further comprises:
performing a batch normalization (BN) operation based on the result of the first convolution operation; and
performing a first activation operation based on a result of the BN operation.

8. The method of claim 7, wherein the performing of the first activation operation comprises performing a hard (H)-swish 8 activation operation based on a rectified linear unit (ReLU) 8 function based on the result of the BN operation.

9. The method of claim 1, wherein the performing of the second convolution operation comprises:
concatenating the result of the first convolution operation together;
dividing the concatenated result of the first convolution operation into the second chunks; and
performing the second convolution operation by allocating the second chunks to the plurality of second IMC macros.

10. The method of claim 9, wherein the dividing of the concatenated result of the first convolution operation into the second chunks comprises dividing the concatenated result of the first convolution operation into the second chunks such that a size of each channel of the concatenated result of the first convolution operation is less than or equal to a number of rows of the plurality of second IMC macros.

11. The method of claim 1, further comprising:
matching a size of a result of the second convolution operation to a size of the input vector; and
performing an add operation between the result of the second convolution operation matched to the size of the input vector and an input value of the first convolution operation.

12. The method of claim 11, further comprising:
performing a pooling operation based on a result of the add operation; and
performing a fully connected operation based on a result of the pooling operation.

13. The method of claim 1, wherein either one or both of the plurality of first IMC macros and the plurality of second IMC macros is configured to perform frame-wise incremental computation.

14. The method of claim 1,
wherein the input vector corresponds to at least a portion of a sequentially input audio stream and the dividing of the input vector comprises dividing the input vector based on the audio stream, and
further comprising identifying a keyword comprised in the audio stream based on a result of the second convolution operation.

15. The method of claim 1, wherein the first convolution operation and the second convolution operation comprise a one-dimensional (1-D) convolution operation.

16. A processor-implemented method comprising:
receiving an audio stream;
performing a first convolution operation on first chunks obtained by dividing an input vector comprising a plurality of channels based on the audio stream;
performing a second convolution operation on second chunks obtained by dividing a result of the first convolution operation; and
identifying a keyword comprised in the audio stream based on a result of the second convolution operation.

17. The method of claim 16, wherein the performing of the first convolution operation comprises:
dividing the input vector into the first chunks such that a size of each of the channels of the input vector comprised in a first chunk is less than or equal to a number of rows of a plurality of first in-memory computing (IMC) macros; and
performing the first convolution operation by allocating the first chunks to the plurality of first IMC macros.

18. The method of claim 16, wherein the performing of the second convolution operation comprises:
concatenating the result of the first convolution operation together;
dividing the concatenated result of the first convolution operation into the second chunks such that a size of each channel of the concatenated result of the first convolution operation is less than or equal to a number of rows of the plurality of second IMC macros; and
performing the second convolution operation by allocating the second chunks to the plurality of second IMC macros.

19. An apparatus comprising:
a receiver configured to receive an input vector comprising a plurality of channels;
one or more processors configured to divide the input vector into first chunks, perform a first convolution operation by allocating the first chunks to a plurality of first in-memory computing (IMC) macros, concatenate a result of the first convolution operation together, divide the concatenated result of the first convolution operation into second chunks, and perform a second convolution operation by allocating the second chunks to a plurality of second IMC macros; and
a memory device comprising either one or both of the plurality of first IMC macros and the plurality of second IMC macros.

20. The neural network operation apparatus of claim 19, wherein, for the dividing of the input vector, the one or more processors are configured to divide the input vector into the first chunks such that a size of the input vector comprised in a first chunk in a channel direction is less than or equal to a number of rows of the plurality of first IMC macros.
